(19) United States
(12) Patent Application Publication
(10) Pub. No.: US 2006/0153344 A1
(43) Pub. Date: Jul. 13, 2006

(54) Electronic recording and playback device

(76) Inventor: Seungsoo Lee, San Marcos, CA (US)

Correspondence Address: MCCARTER & ENGLISH, LLP, FOUR GATEWAY CENTER, 100 MULBERRY STREET, NEWARK, NJ, 07102, US

(21) Appl. No.: 11/315,740

(22) Filed: Dec. 22, 2005

Related U.S. Application Data
(60) Provisional application No. 60/640,187, filed on Dec. 29, 2004.

(51) Int. Cl. H04M 1/24; H04M 1/64

(52) U.S. Cl. 379/67.1; 379/1.01

(57) ABSTRACT

A recording and playback device which is adapted to play a pre-programmed recording together with a personalized recording is disclosed. More particularly, the device is adapted to synchronize playback of the personalized recording with playback of the pre-programmed recording without the use of complex and/or complicated circuitry. As a result, the device can be utilized in various low-cost products, such as candles designed to play music to enhance amusement.

### CROSS-REFERENCE TO RELATED APPLICATION

This application claims the benefit of U.S. Provisional Application Ser. No. 60/640,187, filed Dec. 29, 2004, the disclosure of which is incorporated herein by reference in its entirety for all purposes.

### FIELD OF THE INVENTION

The present invention relates to electronic recording and playback devices and, more particularly, to an electronic recording and playback device adapted to play back a pre-programmed recording along with a personalized recording.

### BACKGROUND OF THE INVENTION

Various electronic devices adapted to play pre-recorded sounds have been developed in the past. For instance, U.S. Pat. No. 5,860,065 discloses an electronic device adapted to play a personalized message recorded by a user together with background music. The electronic device of the '065 patent utilizes relatively complicated circuitry, including mixing circuitry, and is therefore expensive to manufacture, thereby inhibiting its use in connection with various low-cost products, such as musical candles designed to play music to enhance amusement.

### SUMMARY OF THE INVENTION

The present invention overcomes the disadvantages and shortcomings of the prior art discussed above by providing a recording and playback device, comprising a housing; and an electronic circuit housed within the housing and having a first portion for storing a pre-programmed recording and a second portion for storing a personalized recording input by a user, the circuit being operable to play back the pre-programmed recording and the personalized recording, the circuit being operable to play back the personalized recording at a time period during the playback of the pre-programmed recording, wherein the pre-programmed recording is substantially inaudible during the time period. The device of the present invention can be utilized in various low-cost products, such as candles designed to play music to enhance amusement.

### BRIEF DESCRIPTION OF THE DRAWINGS

For a more complete understanding of the present invention, reference is made to the following detailed description of exemplary embodiments of the present invention considered in conjunction with the accompanying drawings, in which:

FIG. 1 is a schematic block diagram of a recording and playback device constructed in accordance with a first embodiment of the present invention;

FIG. 2 is a schematic circuit diagram of the device shown in FIG. 1;

FIG. 3A is a trigger sequence diagram illustrating an exemplary way to synchronize the playback of pre-programmed integrated circuit (PIC) and recordable integrated circuit (RIC) chips utilized in the device shown in FIG. 1;

FIG. 3B is a timing sequence diagram illustrating another exemplary way to synchronize the playback of the PIC chip and the RIC chip of the device shown in FIG. 1;

FIG. 4 is a front elevational view of a candle device incorporating the device shown in FIG. 1;

FIG. 5 is a rear elevational view of the candle device shown in FIG. 4;

FIG. 6 is a side elevational view of the candle device shown in FIG. 4;

FIG. 7 is a block diagram of a recording and playback device constructed in accordance with a second embodiment of the present invention; and

FIG. 8 is a block diagram of a recording and playback device constructed in accordance with a third embodiment of the present invention.

### DETAILED DESCRIPTION OF THE EXEMPLARY EMBODIMENTS

It is to be understood that the illustrations presented herein are offered for purposes of illustration and are not intended to limit the scope of the present invention. Accordingly, types of objects containing the present invention are not limited to the embodiments shown and described herein.

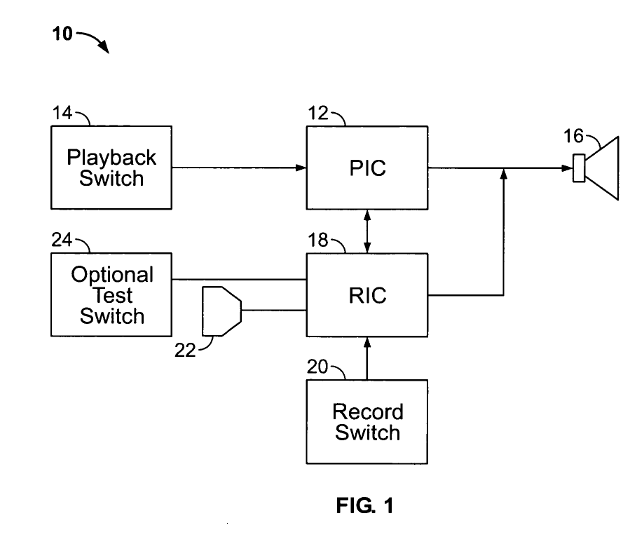

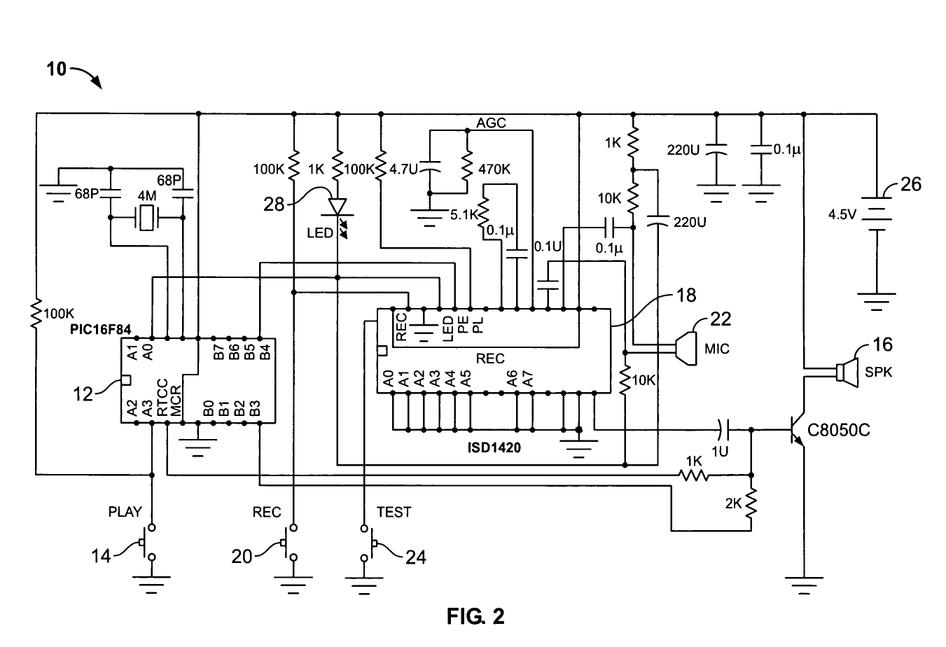

Referring to FIGS. 1 and 2, there is shown a recording and playback device 10 constructed in accordance with a first embodiment of the present invention. More particularly, the device 10 includes a pre-programmed integrated circuit (referred to hereinafter as “the PIC chip”) 12. The PIC chip 12 can be any suitable PIC chip, such as those sold by Microchip Technology, Inc. under part no. PIC16F84. The PIC chip 12 is connected to a playback switch 14, as well as to a speaker 16. When the playback switch 14 is pressed or otherwise actuated, the PIC chip 12 is activated so as to play a pre-programmed or preset message, song, audible sound and the like electronically stored therein (referred to hereinafter as “the pre-programmed recording”) by outputting electrical signals to the speaker 16. The pre-programmed recording is preferably factory-set such that it cannot be changed or modified by an end user. Alternatively, the PIC chip 12 can be configured such that the pre-programmed recording can be modified, changed or recorded over by an end user.

A recordable integrated circuit 18 (referred to hereinafter as “the RIC chip”) is connected to the PIC chip 12 and/or the speaker 16. The RIC chip 18 can be any suitable RIC chip, such as those sold by Winbond Electronics Corporation under part no. ISD1420. The RIC chip 18 is adapted to electronically record or store therein a personalized message, greeting, sound and the like (referred to hereinafter as “the personalized recording”) provided by an end user for playback along with the pre-programmed recording stored in the PIC chip 12. The RIC chip 18 is also connected to a recording switch 20 and a microphone 22. When the recording switch 20 is activated, a user can speak into the microphone 22 so as to record a desired message or other sounds (i.e., the personalized recording) into the RIC chip 18. An optional test switch 24 is connected to the RIC chip 18 such that the personalized recording recorded by the user can be played back through the speaker 16 when the test switch 24 is pressed or otherwise actuated.

FIG. 2 is a schematic circuit diagram showing how components of the device 10 are connected to each other. For example, a voltage source 26 is connected to the power input of each of the PIC chip 12 and the RIC chip 18. With regard to the PIC chip 12, the playback switch 14, when closed, provides voltage from the voltage source 26 to the power input of the PIC chip 12, thereby initiating playback of the pre-programmed recording (e.g., the “Happy Birthday” song). The PIC chip 12 preferably has an output connected to the RIC chip 18 for signaling the RIC chip 18 to play the personalized recording recorded therein. This signaling is preferably performed by way of a timing signal that causes the RIC 18 to play in synchronicity with the PIC chip 12. Alternatively, the PIC chip 12 and/or the RIC chip 18 can send triggering signals to each other to synchronize the playback of the pre-programmed recording with the playback of the personalized recording.

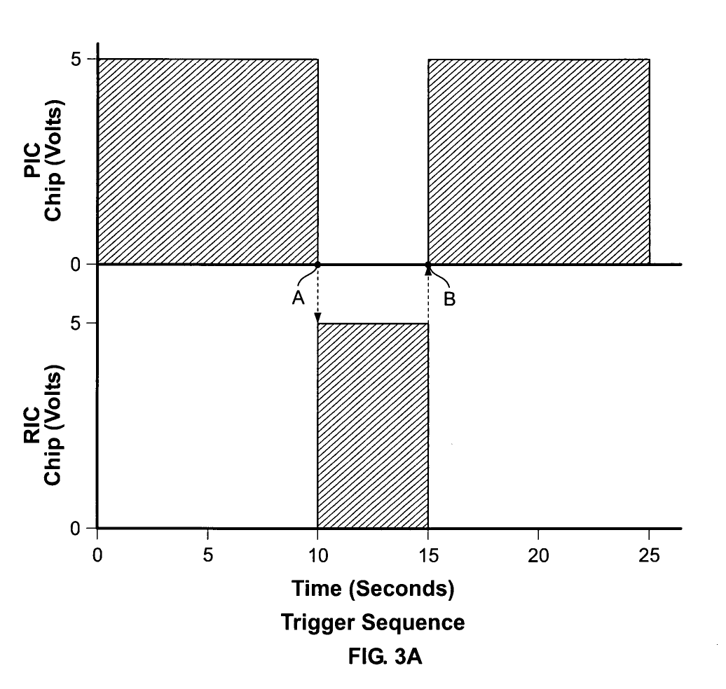

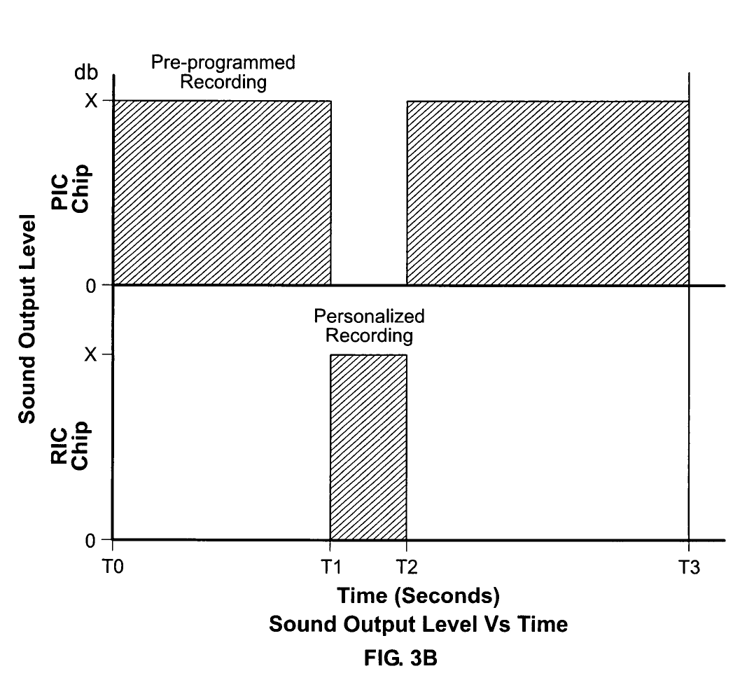

FIG. 3A is a trigger sequence diagram illustrating one exemplary way in which the PIC chip 12 and the RIC chip 18 can be triggered to have alternating outputs. More particularly, the PIC chip 12 can be adapted to trigger the RIC chip 18 to play the personalized recording stored therein after the PIC chip 12 has played a predetermined portion (referred to hereinafter as “the first portion”) of the pre-programmed recording (e.g., the part of the “Happy Birthday” song preceding the name of the recipient). For instance, the PIC chip 12 can be configured to change its logic state (see point A in FIG. 3A) and to transmit a trigger signal to the RIC chip 18 after completing the playback of the first portion of the pre-programmed recording for the purpose of triggering the RIC chip 18 to start playing the personalized recording (e.g., the name of the intended recipient recorded into the RIC chip 18 by the user). The PIC chip 12 can also be configured to receive a trigger signal from the RIC chip 18 when the RIC chip 18 changes its logic state (see point B in FIG. 3A). The change in the logic state of the RIC chip 18 occurs when the RIC chip 18 has finished playing the personalized recording, and such change can be used as a trigger for the PIC chip 12 to continue on with the rest of the pre-programmed recording (e.g., the rest of the “Happy Birthday” song following the name of the recipient).

With regard to the trigger signals mentioned above, one signal that can be used to trigger the RIC chip 18 is an output signal transmitted from the PIC chip 12 to a light emitting diode (LED) 28 to illuminate same while electrical signals are being provided from the PIC chip 12 to the speaker 16. More particularly, this output signal can be transmitted to an input of the RIC chip 18 (preferably via additional circuitry such as an inverter, etc.) so as to provide a trigger to activate the RIC chip 18. In other words, when the output signal to the LED 28 changes its logic state because the pre-programmed recording has stopped, the change in logic state (see point A in FIG. 3A) can be used as a trigger to start the playback of the RIC chip 18. After the RIC chip 18 has finished playing the personalized recording (see point B in FIG. 3A), an End of Message signal (or similar logic signal) that is output from the RIC chip 18 can be used to trigger the PIC chip 12 to start playing again to finish the rest of the pre-programmed recording, and possibly repeat the entire sequence with the RIC chip 18 in a loop. Other known ways to trigger an integrated circuit can be used in conjunction with the present invention to activate and/or deactivate the PIC chip 12 and/or the RIC chip 18.

In use, the device 10 can have numerous applications. For instance, the PIC chip 12 can, as indicated above, be pre-programmed to play the “Happy Birthday” song with the exception of the part where the word “dear” and the recipient's name are sung (referred to hereinafter as “the ‘Dear’ part”), while the RIC chip 18 can be configured so as to allow a user to record thereinto the “Dear” part of the “Happy Birthday” song. In this particular application, the user can speak into the microphone 22 his/her own “Dear” part (e.g., “Dear John”, “Dear Jane”, etc.) after pressing the recording switch 20 so as to record same in the RIC chip 18. Alternatively, the word “Dear” can be included as part of the pre-programmed recording such that the user needs to record only the name of the recipient without the word “Dear”. In order to minimize manufacturing expenses, the RIC chip 18 can be provided with a recording length or time just enough for the user to record the “Dear” part (e.g., the RIC chip 18 can be provided with a recording length of about five seconds). When the playback switch 14 is actuated, the PIC chip 12 plays through the speaker 16 the first portion of the “Happy Birthday” song (i.e., “Happy Birthday to you, Happy Birthday to you, Happy Birthday”). After completing the playback of the first portion of the “Happy Birthday” song, the PIC chip 12 stops the output (see point A in FIG. 3A) and causes the RIC chip 18 to play the “Dear” part that has been previously recorded by the user. After the RIC chip 18 finishes playing the “Dear” part, the RIC chip 18 signals the PIC chip 12 that it has finished playing the “Dear” part so as to trigger the PIC chip 12 to resume playing the remainder of the “Happy Birthday” song (see point B in FIG. 3A). Alternatively, the PIC chip 12 can be configured to automatically resume the playback of the “Happy Birthday” song after the lapse of a time period (e.g., five seconds) corresponding to the recording length provided in the RIC chip 18. The PIC chip 12 plays to the end of the recording and stop, or start playing the pre-programmed recording again (and possibly repeat in a “loop”). In the foregoing manner, the entire “Happy Birthday” song can be played by the device 10 with the “Dear” part personalized by the user.

FIG. 3B illustrates another way to synchronize the playback of the pre-programmed recording with the playback of the personalized recording. In this example, the PIC chip 12 and the RIC chip 18 do not directly send triggering signals to one another for synchronization as discussed in connection with the example illustrated in FIG. 3A. More particularly, the PIC chip 12, in this example, is configured to play the entire pre-programmed recording (e.g., the “Happy Birthday” song without the “Dear” part) without an interruption or pause. In order to allow the playback of the personalized recording, the pre-programmed recording is provided with a “blank” sound output (no sound) portion, the length of which corresponds to the recordable length (e.g., about five seconds) provided in the RIC chip 18. The blank portion can be created by erasing a certain portion of the pre-programmed recording or recording a blank (i.e., no sound) portion in the pre-programmed recording for a predetermined amount of time (e.g., five seconds). The RIC chip 18 is configured so as to synchronize the playback of the personalized recording recorded therein with the playback of the blank portion of the pre-programmed recording (i.e., the RIC chip 18 is triggered to play the personalized recording when the blank portion of the pre-programmed recording begins to play). Even though electrical signals from both the PIC chip 12 and the RIC chip 18 are fed directly and concurrently to the speaker 16 during the playback of the personalized recording, because no audible sound is generated by the playback of the blank portion, the personalized recording can be played without interference with the continuous playback of the pre-programmed recording. As a result, the personalized recording and the pre-programmed recording can be played back without utilizing a mixer for mixing outputs of the PIC chip 12 and the RIC chip 18.

Still referring to FIG. 3B, the operation of the PIC chip 12 and the RIC chip 18 will be discussed greater detail hereinbelow in connection with the playback of the “Happy Birthday” song with the personalized “Dear” part. When the playback switch 14 is pressed, the PIC chip 12 plays the first portion of the “Happy Birthday” song (i.e., the portion of the “Happy Birthday” song preceding the recipient's name) recorded therein during the time interval from T0 to T1. During the time interval from T1 to T2, the PIC chip 12 plays the blank portion, while the RIC chip 18 plays the “Dear” part recorded therein by the user. Subsequently, from time T2 to time T3, the PIC chip 12 provides the remainder of the pre-programmed recording (i.e., the “Happy Birthday” song) as an output to the speaker 16. The actual time allotted to the PIC chip 12 should correspond almost exactly to the time it takes to play the pre-programmed recording, so as not to have a lapse in the output from the speaker 16.

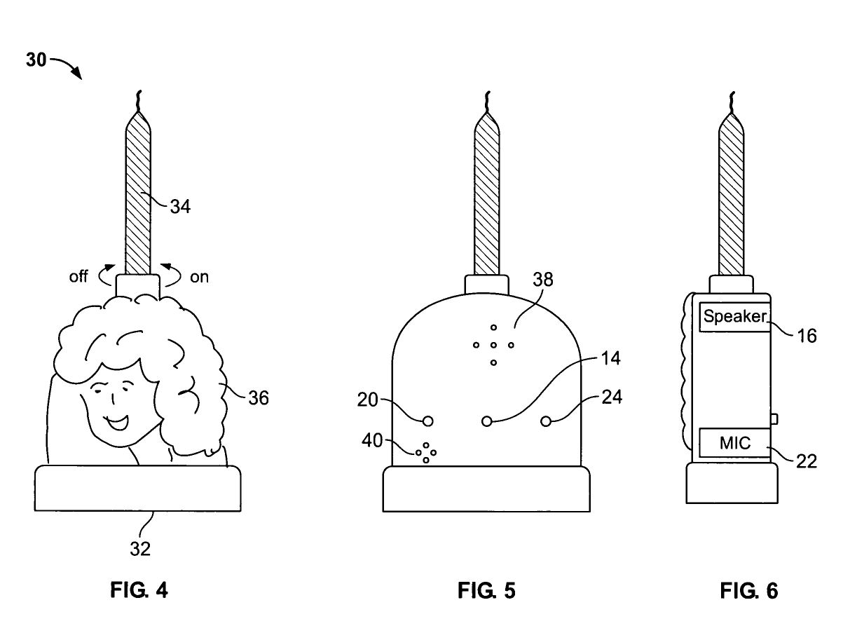

FIGS. 4, 5 and 6 illustrate an electronic birthday greeting figurine/cake topper 30 (referred to hereinafter as “the cake topper”) equipped with the device 10. The construction and operation of the cake topper 30 will be discussed hereinafter in conjunction with a musical birthday candle device (i.e., a musical candle device adapted to play the “Happy Birthday” song). It should be, however, noted that the following discussion of the cake topper 30 is offered for illustrative purposes only and is not meant to limit the scope of the present invention, which has applicability to other types of playback devices.

Referring to FIG. 4, the cake topper 30 has a base 32 which provides support for a body 36 and a candle 34. The body 36 may house some or even the bulk of the recording and playback device 10, and may have a compartment (not shown) for holding batteries. As shown, the candle 34 may by rotatable so as to provide an on/off function (see applicant's U.S. Pat. No. 6,808,388, the disclosure of which is incorporated herein by reference in its entirety). If the candle 34 is rotated to one direction the power to the device 10 can be cut off, and could also serve as a volume switch when rotated in the other direction. Once the candle 34 is rotated to an on position, the pre-programmed recording (i.e., the “Happy Birthday” song) can begin to play. The body 36 may have a decorative exterior that could be, for example, the image of a celebrity, such as a movie star, athlete, etc.

As shown in FIG. 5, the body 36 also has a functional back side used to program and activate the device 10. For example, speaker holes 38 are arranged to permit sound to exit the interior of the body 36. It should be noted that the speaker holes 38 may be arranged directly in front of a speaker (shown in FIG. 6). Thus, the body 36 acts as a type of shroud for the speaker 16 to protect it from damage, and the speaker holes 38 permit the sound to exit. There are also air holes 40 (see FIG. 5) for the microphone 22 of the device 10 arranged in the body 36 to permit a user to personalize the cake topper 30.

The cake topper 30 can be personalized by pressing the record switch 20 and saying, for example, the name of the person having the birthday. The test switch 24, when pressed, permits playback of the sounds recorded in the RIC chip 18. By pressing the playback switch 14, the cake topper 30 plays the pre-programmed recording and the personalized recording in the manner described above.

FIG. 6 is a side elevational view of the cake topper 30 shown in FIGS. 4 and 5. As depicted by the dashed lines, the speaker 16 and the microphone 22 may be arranged therein.

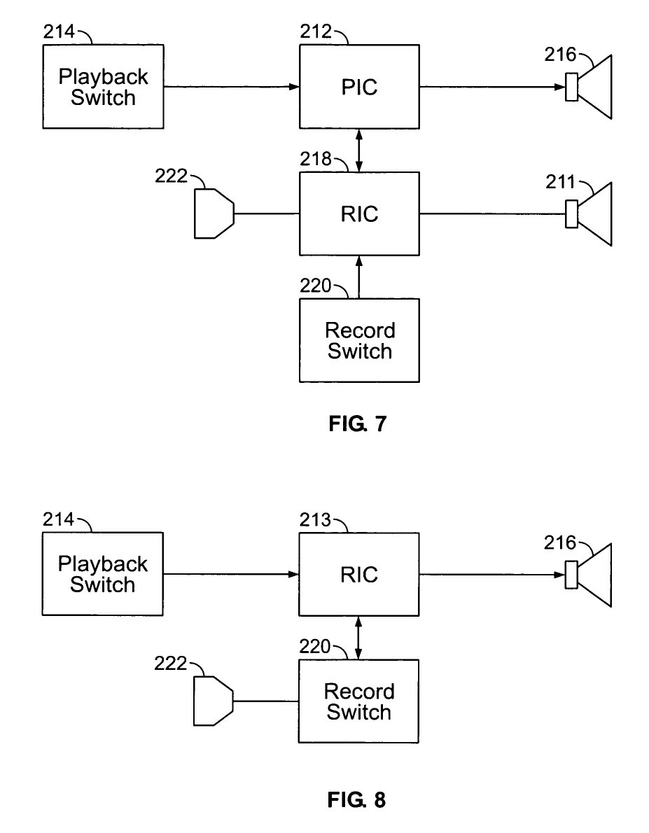

FIG. 7 illustrates another exemplary embodiment of the present invention. Elements illustrated in FIG. 7, which correspond, either identically or substantially, to the elements described above with respect to the embodiment of FIGS. 1-6, have been designated by corresponding reference numerals increased by one hundred. Unless otherwise stated, the embodiment of FIG. 7 has a construction and operation which are basically identical to those of the embodiment of FIGS. 1-6.

With reference to FIG. 7, a RIC chip 118 is connected to a speaker 111, while a PIC chip 112 is connected to a speaker 116 which is separate from the speaker 111. Thus, each of the PIC and RIC chips 112, 118 has its own respective output connected to a corresponding one of the speakers 111, 116. The construction, operation and functions of the PIC and RIC chips 112, 118 are otherwise similar to those described in connection with the embodiment of FIG. 1.

FIG. 8 illustrates yet another embodiment of the present invention. Elements illustrated in FIG. 8, which correspond, either identically or substantially, to the elements described above with respect to the embodiment of FIGS. 1-6, have been designated by corresponding reference numerals increased by two hundred. Unless otherwise stated, the embodiment of FIG. 8 has a construction and operation which are basically identical to those of the embodiment of FIGS. 1-6. In this particular embodiment, the PIC chip 12 of the embodiment shown in FIGS. 1-6 is completely eliminated. Instead of a pre-programmed recording being recorded in the PIC chip 12, the entire song, including the personalized recording, is provided on a RIC chip 218. More particularly, the “Happy Birthday” song is pre-recorded on the RIC chip 218 for a certain amount of time. The RIC chip 218 is programmed to only permit a recording after the certain amount of time has passed, so that a personalized recording can be added without recording over the pre-programmed recording. For example, a typical RIC chip 218 has a pin (not shown) that is an input for a signal to record from an external source. A logic level that would prevent the RIC chip 218 from recording from an external source can be applied to disable the record feature for a predetermined amount of time that would prevent the first part of a previously recorded song from being recorded on by a user. After the predetermined time passes, the RIC chip 218 may receive a signal with a different logic level to permit recording.

With regard to the embodiments discussed above, the recording and playback device of the present invention permits personalized sounds to be played sequentially with pre-programmed sounds, without the use of complex mixing circuits. The interaction of the integrated circuits according to either time or signal level provides advantages in power consumption, size and an ability to personalize a portion of the output heretofore unknown.

Although illustrative embodiments and exemplary aspects of the present disclosure have been described with reference to the illustrations herein, the present disclosure is not limited thereto. Rather, the various structural components and/or assemblies disclosed herein, which have been provided for purposes of illustration and not for limitation, are susceptible to modification and/or variation without departing from the scope and spirit of the present invention as defined in the appended claims. Furthermore, it will be understood by those skilled in the pertinent art based on the teachings herein that the above-discussed structural components/features may be operatively connected to form a variety of different construction combinations.

What is claimed is:

1. A recording and playback device comprising a housing; and an electronic circuit housed within said housing and having a first portion for storing a pre-programmed recording and a second portion for storing a personalized recording input by a user, said circuit being operable to play back said pre-programmed recording and said personalized recording, said circuit being operable to play back said personalized recording at a time period during the playback of said pre-programmed recording, wherein said pre-programmed recording is substantially inaudible during said time period.

2. The recording and playback device of claim 1, wherein said first portion is formed as a first integrated circuit; and wherein and said second portion is formed as a second integrated circuit which is separate from said first integrated circuit.

3. The recording and playback device of claim 2, wherein said first integrated circuit is a pre-programmed integrated circuit; and wherein said second integrated circuit is a recordable integrated circuit.

4. The recording and playback device of claim 3, wherein said pre-programmed integrated circuit is in electrical communication with said recordable integrated circuit.

5. The recording and playback device of claim 4, wherein said pre-programmed recording is audible during a first time interval which precedes said time period and during a second time interval which follows said time period.

6. The recording and playback device of claim 5, wherein said pre-programmed integrated circuit is operable to electronically send a first trigger signal to said recordable integrated circuit at the end of said first time interval for causing said recordable integrated circuit to play back said personalized recording, said pre-programmed integrated circuit being disabled upon sending said first trigger signal.

7. The recording and playback device of claim 6, wherein said recordable integrated circuit is operable to electronically send a second trigger signal to said pre-programmed integrated circuit at the end of said time period for causing said pre-programmed integrated circuit to resume the playback said pre-programmed recording.

8. The recording and playback device of claim 7, wherein said pre-programmed integrated circuit is operable to play a blank sound output during said time period.

9. The recording and playback device of claim 8, wherein said circuit includes:
a first speaker in electronic communication with said pre-programmed integrated circuit for playing back said pre-programmed recording;
a second speaker in electronic communication with said recordable integrated circuit for playing back said personalized recording; and
a microphone in electronic communication with said recordable integrated circuit for recording said personalized recording.

10. The recording and playback device of claim 8, wherein said circuit includes:
a speaker in electronic communication with said pre-programmed integrated circuit and said recordable integrated circuit for playing back said pre-programmed recording and said personalized recording; and
a microphone in electronic communication with said recordable integrated circuit for recording said personalized recording.

11. The recording and playback device of claim 1, wherein said first portion and said second portion are formed as a single integrated circuit.

12. The recording and playback device of claim 11, wherein said single integrated circuit is a recordable integrated circuit.

13. The recording and playback device of claim 12, wherein said circuit includes:
a speaker in electronic communication with said recordable integrated circuit for playing back said pre-programmed recording and said personalized recording; and
a microphone in electronic communication with said recordable integrated circuit for recording said personalized recording.
